(19) United States
(12) Patent Application Publication
(10) Pub. No.: US 2025/0136002 A1
(43) Pub. Date: May 1, 2025

(54) SYSTEM AND METHOD FOR OPERATING A FRONT TRUNK OF AN ELECTRIC VEHICLE

(71) Applicant: FCA US LLC, Auburn Hills, MI (US)

(72) Inventors: Patrick Duane Reed, Washington, MI (US); Jason Lester Vincent, Howell, MI (US); Richard Stephen Silbert, Bingham Farms, MI (US)

(21) Appl. No.: 18/494,096

(22) Filed: Oct. 25, 2023

(51) Int. Cl. B60R 5/02

(52) U.S. Cl. CPC B60R 5/02; B60R 2225/00; B60R 2300/8093

(57) ABSTRACT

A front trunk system for an automotive vehicle having a front trunk door having front trunk closed path includes a sensor generating an obstacle signal corresponding to an obstacle across the front trunk closed path and a controller coupled to the sensor controlling an indicator when the obstacle is the front trunk closed path.

### FIELD

The present disclosure relates to a front truck, and more specifically to a method and system for operating the front trunk.

### BACKGROUND

This section provides background information related to the present disclosure which is not necessarily prior art.

Electrified vehicles have batteries that are located in various locations throughout the vehicle. The location of the battery is not in the front of the vehicle like a typical internal combustion engine. Therefore, space in front of the passenger compartment is available for storage. The storage area in front of the vehicle is referred to as a front trunk (frunk) or front cargo area. The frunk is a highly desired customer feature.

A frunk typically has more limited cargo space than a traditional trunk. A front door typically encloses the frunk and may also be referred to as a hood. Because of the limited cargo space, there are risks associated with overfilling of the frunk. The objects being stored within the frunk may be damaged. The door or hood for closing the frunk may also be damaged. In certain countries, pedestrian protection is provided in the front of the vehicle and incorporates the hood or frunk door. Deforming the hood or frunk door may prevent vehicles from complying with the pedestrian protection.

### SUMMARY

This section provides a general summary of the disclosure and is not a comprehensive disclosure of its full scope or all of its features.

The present disclosure generates an alert through an indicator to the vehicle operator to prevent damage to the vehicle or objects inside should the frunk be closed.

In one aspect of the disclosure, a front trunk system for an automotive vehicle having a front trunk door having front trunk closed path includes a sensor generating an obstacle signal corresponding to an obstacle across the front trunk closed path and a controller coupled to the sensor controlling an indicator when the obstacle is the front trunk closed path.

In another aspect of the disclosure, a method of controlling a front trunk system for an automotive vehicle having a front trunk door having front trunk closed path is set forth. The method includes generating an obstacle signal corresponding to an obstacle across the front trunk closed path and controlling an indicator when the obstacle is the front trunk closed path.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations and are not intended to limit the scope of the present disclosure.

FIG. 1A is a diagrammatic view of a motor vehicle having a front trunk.

FIG. 1B is one example of a user interface illustrated in FIG. 1A.

FIG. 1C is a front trunk door in a partial open and a closed position with the obstacle sensors therein.

FIG. 2 is a block diagrammatic view of the system.

FIG. 3 is a flowchart of a method for operating the system.

Corresponding reference numerals indicate corresponding parts throughout the several views of the drawings.

### DETAILED DESCRIPTION

Example embodiments will now be described more fully with reference to the accompanying drawings.

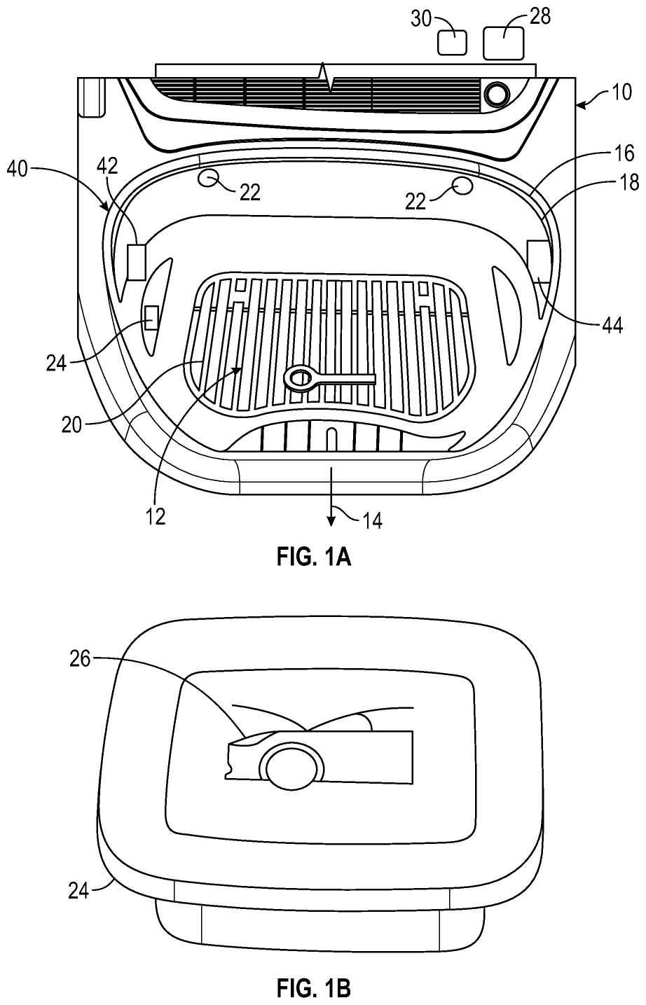

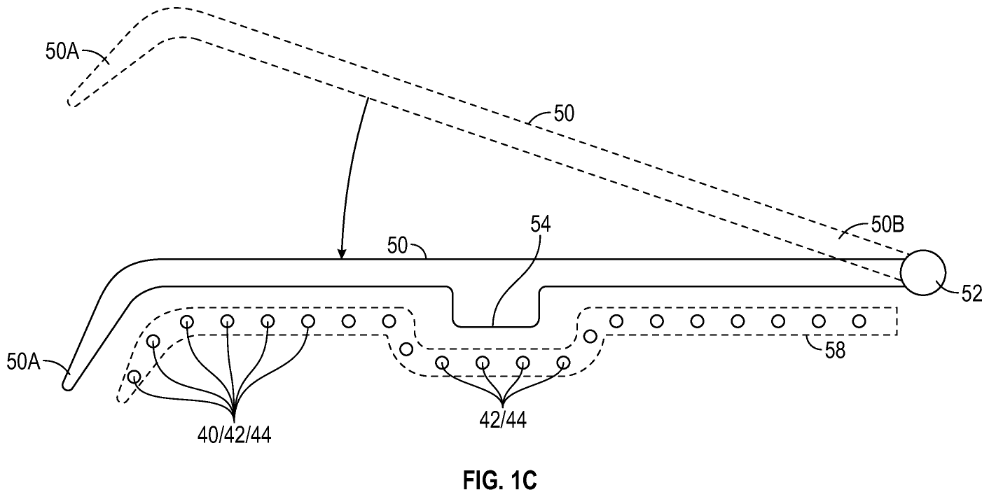

Referring now to FIG. 1A, an automotive vehicle 10 having a front trunk 12 is illustrated. The front trunk 12 is illustrated without a front door or hood so that the interior of the front trunk 12 is illustrated. In this example, the front trunk 12 has a length in the direction of the longitudinal axis 14. The front trunk has a lateral width and depth to hold cargo. Typically, the frunk is molded from plastic or another finish. The surfaces may be carpeted. Frunks for different vehicles will have different shapes depending upon the package size and the vehicle design.

The front trunk 12 has an opening 16 that may be sealed by a rubber seal 18 to prevent water from intruding. The front trunk 12 has a load floor 20 that is used for supporting the objects within the front trunk 12. Lights 22 may be disposed at various locations within the front trunk 12 so that when the front trunk door is opened, the lights 22 are illuminated to illuminate the objects within the front trunk 12. In this example, two lights 22 are illustrated. However, one light or more than two lights 22 are used in different examples. The lights 22 may also be referred to as an indicator to indicate an obstacle as will be described in more detail below. The lights 22 may be incandescent lights or another type of light source such as a light emitting diode or plurality of diodes.

Referring now also to FIG. 1B, one example of a user interface 24 is set forth. The user interface 24, in this example, has an image 26 that is indicative of a control for the front trunk 12. The user interface 24, as illustrated in FIG. 1A, is located in the interior of the frunk. The user interface 24 may also be illuminated or back lit and may be used as an emergency latch for someone trapped within the front trunk 12. That is, the user interface 24 can act as a release to unlatch the front trunk 12.

A user interface 28, in this example, is disposed within the vehicle 10. The user interface 28 may be a separate push button or an electronic button displayed on a touch screen display such as a center console screen display.

An indicator 30 disposed within the passenger compartment is used in this example. The indicator 30 illuminates when an object is detected by the obstacle sensor 40. The indicator 30 and the lights 22, as well as the interface 24, may illuminate when an obstacle is detected by the obstacle sensor 40. A positive illumination may also be used. For example, the user interface 24, the indicator 30 and the lights 22 may be white or green lights when the obstacle sensor 40 does not detect an obstacle in the path of the front trunk 12 and red when an obstacle is present.

The obstacle sensor 40, in this example, has an emitter 42 and a receiver 44 located on opposite sides of the front trunk 12. One example of an emitter 42 is an optical emitter generating an optical signal. However, other types of emitters may be used including, but not limited, to an ultrasonic emitter. The receiver 44, in the optical example, is a photo detector, photo receiver or photo diode. An ultrasonic receiver may also be used for an ultrasonic emitter. Signal may be generated at the receiver indicative of receiving the optical signal from the emitter 42 (not obstacle) and not receiving light (obstacle in path).

Referring now to FIG. 1C, a cross-sectional view of a front trunk door 50 illustrated in a closed position and an open position is illustrated. In this example, the front trunk door 50 has a front end 50A and a rearmost end 50B. A hinge 52 allows the front trunk door 50 to move between an open and a closed position. The front trunk door 50 may have various support portions 54 extending therefrom. In this example, one support portion 54 is illustrated. However, several support portions may be provided on a front trunk door 50. The support portion 54 may extend downward into the front trunk 12.

In the example set forth in FIG. 1A, one emitter 42 and one receiver 44 are illustrated. However, the emitter 42 may be a plurality of optical emitters and the receiver 44 may be a plurality of optical receivers. As illustrated in FIG. 1C, the circles illustrate the alignment of the emitter 42 and the receiver 44 laterally across the vehicle. The plurality of emitters 42 and the plurality of receivers 44 are disposed in a lateral projection zone 58 of the front trunk closed path 58. That is, the lateral projection zone 58 is about or at the area that is to be projected laterally across the vehicle 10. If a projection of a portion of the obstacle is laterally within the zone 58, it is desirable not to close the front truck door. The front trunk closed zone 58 is shaped to provide a region corresponding generally to the shape of the inside of the front trunk door 50. For example, the front trunk closed path is positioned downward at the support portion 54. The front trunk closed path 58 provides the upper region desired for the contents of the front trunk 12. Should objects in the front trunk 12 extend to the level of the emitters 42 and the receivers 44, the lights 22, the user interface 24 and the indicator 30 may generate a visual indicator of an obstacle. Only one out of a plurality of receivers may be blocked from light to prevent the front trunk door 50 from being closed automatically or generate an indicator indicating an obstacle of the door path.

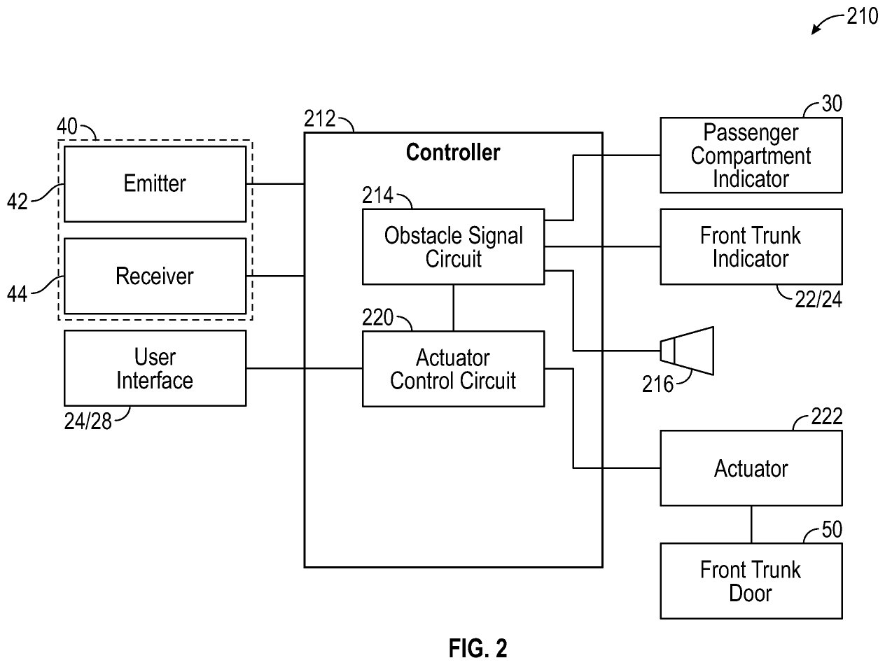

Referring now to FIG. 2, a block diagrammatic view of a front trunk system 210 having a controller 212 is set forth. The controller 212 may be formed of a microprocessor or discrete circuitry used for controlling the various functions. An obstacle signal circuit 214 is disposed within the controller 212. The obstacle signal circuit 214 may control the passenger compartment indicator 30, the lights 22 and/or the user interface 24. Likewise, a speaker 216 or other acoustic generating device may be used to generate an audible indicator. As mentioned above, the obstacle signal circuit 214 may generate or control the indicators 22, 24 and 30 to indicate an obstacle is in the path of the door 50. For example, a red indicator light may be used. The obstacle signal circuit 214 may also generate an indicator when the path is clear, such as a white light. The change between the white light and the red light is used to indicate an obstacle.

The controller 212 may include an actuator control circuit 220 in communication with the obstacle signal circuit 214. The actuator control circuit 220 is used to control an actuator 222 for an automatic front trunk closing system. That is, the actuator 222 and the door 50 associated therewith may close off the front trunk 12 by moving the front trunk door 50 associated therewith. One example of an actuator 222 is a motor. The user interface 24/28 is used to provide an input signal to the actuator control circuit 220 when the front trunk door 50 is desired to be closed. The user interface 24/28 may also be used to open the front trunk door 50 by controlling the actuator 222. Controlling the actuator may be based on signals from the obstacle signal circuit 214.

The audible indicator or speaker 216 may also include the user of the vehicle horn or a fratzonic resonance chamber.

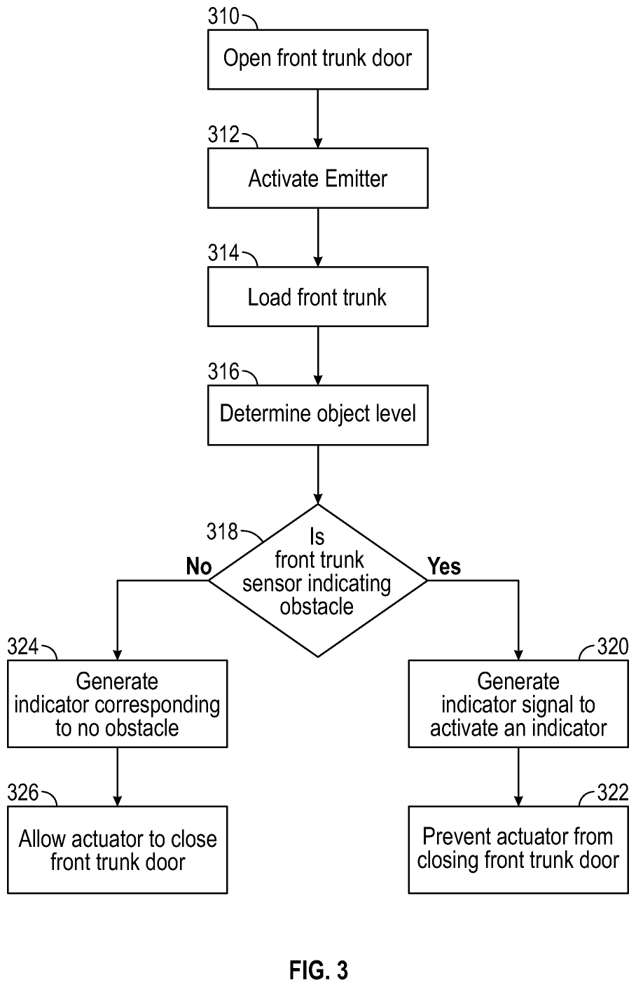

Referring now to FIG. 3, a flowchart of a method for controlling the system 210 of FIG. 2 is set forth. In step 310, the door 50 of the front truck 12 is opened. A manual latch may be provided. However, a remote control device or another type of user interface, such as the user interface 24, may be used to open the front trunk door. In step 312, the emitter 42 is activated. By activating the emitter, the receiver may detect and communicate a signal to the controller as described above. The signal may include an obstacle detection or a non-obstacle detection signal. That is, two different types of signals may be communicated. The signals may be simply an on/off or “0” or “1” signal in the digital realm.

In step 314, the front trunk is loaded. The front trunk loaded preferably to a depth below the front trunk closed path 58 and the obstacle sensor 40 associated therewith. Thus, the load or object level is determined in step 316.

In step 318, when the front trunk sensor indicates an obstacle by detecting the object level is too high, an indicator signal is generated to activate an indicator. As mentioned above, the indicator may change the color of one of the indicators or generate an audible indicator in step 320. Step 322 may prevent the actuator from closing the front trunk door.

Referring back to step 318, when the front trunk sensor does not detect an obstacle, an indicator corresponding to no obstacle may be optionally generated in step 324. That is, white lights or a normal closing sound without a warning sound may be generated. In step 326, the front truck door is allowed to be closed by the actuators. Steps 322 and 324 are optional steps corresponding to when a front trunk actuator is present. The front trunk monitoring process may continually be performed after the front trunk is opened or before closing the front trunk door.

Example embodiments are provided so that this disclosure will be thorough and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A front trunk system for an automotive vehicle having a front trunk door having front trunk closed path comprising:
a sensor generating an obstacle signal corresponding to an obstacle across the front trunk closed path; and
a controller coupled to the sensor controlling an indicator when the obstacle is the front trunk closed path.

2. The front trunk system of claim 1 wherein the sensor comprises an emitter and a receiver.

3. The front trunk system of claim 2 wherein the emitter is an optical emitter, and the receiver is an optical receiver.

4. The front trunk system of claim 2 wherein the emitter is disposed on a first side of the front trunk and the receiver is located on an opposite side of the front trunk.

5. The front trunk system of claim 4 wherein the emitter and the receiver are disposed in a lateral projection zone outside of a closed path.

6. The front trunk system of claim 5 wherein the emitter comprises a plurality of emitters and the receiver comprises a plurality of receivers, said plurality of emitters and the plurality of receivers are disposed in the lateral projection zone.

7. The front trunk system of claim 1 wherein the indicator comprises a visual indicator or an audible indicator.

8. The front trunk system of claim 1 wherein the indicator comprises a visual indicator and an audible indicator.

9. The front trunk system of claim 8 wherein the visual indicator is disposed within the front trunk.

10. The front trunk system of claim 1 wherein the sensor comprises an ultrasonic sensor.

11. The front trunk system of claim 1 further comprising a user interface and an actuator for closing the front trunk door, said controller preventing the actuator from closing the front trunk door based on the obstacle signal.

12. A method of controlling a front trunk system for an automotive vehicle having a front trunk door having front trunk closed path, said method comprising:
generating an obstacle signal corresponding to an obstacle across the front trunk closed path; and
controlling an indicator when the obstacle is the front trunk closed path.

13. The method of claim 12 wherein generating the obstacle signal comprises generating the obstacle signal from an optical receiver.

14. The method of claim 12 wherein generating the obstacle signal comprises generating the obstacle signal from an optical receiver on a first side of the front trunk and not receiving an optical signal from an optical emitter on a second side of the front trunk.

15. The method of claim 12 wherein generating the obstacle signal comprises generating the obstacle signal from an optical receiver and not receiving an optical signal from an optical emitter in a lateral projection zone of the closed path.

16. The method of claim 15 wherein generating the obstacle signal comprises generating the optical signal from a plurality of optical receivers based on not receiving the optical signal from at least one of a plurality of optical emitters, said plurality of optical emitters and the plurality of optical receivers are disposed in the lateral projection zone.

17. The method of claim 12 wherein controlling the indicator comprises controlling a visual indicator.

18. The method of claim 12 wherein controlling the indicator comprises controlling a visual indicator disposed within the front trunk.

19. The method of claim 12 wherein the indicator comprises an audible indicator, a visual indicator or both.

20. The method of claim 12 further comprising preventing an actuator from closing the front trunk door after generating an actuator signal based on the obstacle signal.
